(19) United States
(12) Patent Application Publication
(10) Pub. No.: US 2026/0106691 A1
(43) Pub. Date: Apr. 16, 2026

(54) LARGE SCALE ANTENNA WIRELESS COMMUNICATION SYSTEM BASED ON LDPC CODE AND GAUSS-SEIDEL-AIDED MMSE-PIC AND DESIGN METHOD THEREOF

(71) Applicant: Electronics and Telecommunications Research Institute, Daejeon (KR)

(72) Inventor: Han Jin PARK, Daejeon (KR)

(73) Assignee: Electronics and Telecommunications Research Institute, Daejeon (KR)

(21) Appl. No.: 19/348,885

(22) Filed: Oct. 3, 2025

(30) Foreign Application Priority Data
Oct. 11, 2024 (KR) 10-2024-0138442
Aug. 29, 2025 (KR) 10-2025-0122105

(51) Int. Cl. H04L 1/00

(52) U.S. Cl. CPC H04L 1/005; H04L 1/0057

(57) ABSTRACT

A method according to an embodiment of the disclosure is a decoding method in a large-scale antenna wireless communication system, comprising: calculating the number of iterative operations of an external detector; calculating the number of iterative operations of an internal detector; calculating the number of iterative operations of an LDPC (Low-Density Parity-Check) decoder; determining a ratio of the number of iterative operations of the external detector, the number of iterative operations of the internal detector, and the number of iterative operations of the LDPC decoder; and determining that the system operates normally when the determined ratio satisfies a predetermined condition.

### CROSS-REFERENCE TO RELATED APPLICATION

The present application claims priority to Korean Patent Application No. 10-2024-0138442, filed on Oct. 11, 2024 in Korea Intellectual Property Office, and Korean Patent Application No. 10-2025-0122105, filed on Aug. 29, 2025 in Korea Intellectual Property Office, the entire contents of which are incorporated herein by reference.

### TECHNICAL FIELD

The disclosure relates to large scale antenna wireless communication system based on LDPC code and Gauss-seidel-aided MMSE-PIC and design method thereof.

### BACKGROUND

The following description is provided only as background information related to the embodiment and does not constitute a description of related art.

In next-generation communication environments, the demand for transmitting and receiving large amounts of data at high speeds continues to increase. To address this demand, multiple input multiple output (MIMO) techniques were initially developed from single input single output (SISO) techniques.

The MIMO techniques may improve data transmission capacity and transmission efficiency by utilizing multiple transmit and receive antennas, but limitations still exist in fully satisfying the demand for transmitting and receiving large amounts of data.

The technology developed to overcome these limitations is extreme massive MIMO. The extreme massive MIMO systems are one of various technologies for transmitting and receiving large amounts of data in fifth-generation (5G) and sixth-generation (6G) mobile communications, and may dramatically improve transmission capacity by configuring a significantly greater number of transmit and receive antennas compared to conventional MIMO systems.

However, a rapid increase in the number of transmit and receive antennas causes a problem of significantly increasing the amount of computation compared to conventional MIMO systems. In particular, high-performance signal detection algorithms such as the Maximum Likelihood (ML) detector used in MIMO systems have the limitation that when applied directly to extreme massive MIMO systems, computational complexity increases exponentially with the increase in the number of transmit and receive antennas, thereby making real-time processing difficult.

### SUMMARY

An aspect of the disclosure is to provide a large-scale antenna wireless communication system capable of high-speed transmission and reception of data based on LDPC codes and an extreme massive MIMO system with Gauss-seidel-aided MMSE-PIC technique, and a design method thereof.

An aspect of the disclosure is to provide a wireless communication system and design method that, based on LDPC codes and Gauss-Seidel aided MMSE-PIC (Minimum Mean Square Error—Parallel Interference Cancellation) techniques, effectively reduces computational complexity while securing stable signal detection performance even in a large-scale transmission and reception environment required by extreme massive MIMO systems.

An aspect of the disclosure is to provide a wireless communication system and design method that enables real-time implementation of high-performance detection algorithms in an extreme massive MIMO system environment where the number of transmit and receive antennas is significantly greater than in existing MIMO systems, thereby maximizing large amount of data transmission efficiency.

The technical problems to be solved by the disclosure are not limited to the problems mentioned above, and other problems that are not mentioned will be clearly understood by those skilled in the art from the following description.

A method according to an embodiment of the disclosure is a decoding method in a large-scale antenna wireless communication system, including: calculating the number of iterative operations of an external detector; calculating the number of iterative operations of an internal detector; calculating the number of iterative operations of an LDPC (Low-Density Parity-Check) decoder; determining a ratio of the number of iterative operations of the external detector, the number of iterative operations of the internal detector, and the number of iterative operations of the LDPC decoder; and determining that the system operates normally when the determined ratio satisfies a predetermined condition.

An apparatus according to an embodiment of the disclosure is a decoding apparatus in a large-scale antenna wireless communication system, including: a memory including instructions; and a processor configured, by executing the instructions, calculates the number of iterative operations of an external detector, to calculate the number of iterative operations of an internal detector, calculate the number of iterative operations of an LDPC (Low-Density Parity-Check) decoder, check a ratio of the number of iterative operations of the external detector, the number of iterative operations of the internal detector, and the number of iterative operations of the LDPC decoder, and determine that the system operates normally when the determined ratio satisfies a predetermined condition.

The disclosure enables high-speed transmission and reception of data because it is based on LDPC codes and extreme massive MIMO system with Gauss-seidel-aided MMSE-PIC technique.

The disclosure may significantly reduce the amount of computation compared to existing ML detector, thereby enabling real-time processing even in the extreme massive MIMO environment.

The disclosure may secure stable and high signal detection performance even in channel interference and noise environments through the combination of LDPC codes and Gauss-Seidel aided MMSE-PIC.

The disclosure may solve the complexity problem that arises as the number of transmit and receive antennas increases, while simultaneously maximizing the transmission capacity enhancement effect achieved by utilizing large-scale antennas.

The disclosure is applicable to next-generation wireless communication systems such as 5G and 6G, and may be utilized as a core technology to satisfy the demand for transmission and reception of large amounts of data.

The effects of the disclosure are not limited to the effects mentioned above, and other effects that are not mentioned will be clearly understood by those skilled in the art from the following description.

### BRIEF DESCRIPTION OF THE DRAWINGS

FIG. 1 is an exemplary diagram showing an extreme massive MIMO system to which an LDPC code is applied.

FIG. 2 is an exemplary diagram showing iterative operations of a detector and iterative operations of a decoder.

FIG. 3 is a structural diagram of an LDPC coded extreme massive MIMO system applied to an embodiment of the disclosure.

FIG. 4 is a structural diagram of a large-scale antenna wireless communication system based on an LDPC code and Gauss-seidel-aided MMSE-PIC according to an embodiment of the disclosure.

FIG. 5 is a system message flowchart showing a process of exchanging mutual information between a detector and an LDPC decoder according to an embodiment of the disclosure.

FIG. 6 is a flowchart showing a decoding method according to an embodiment of the disclosure.

FIG. 7 is a 3D EXIT chart showing trajectories according to detection-decoding ratios.

FIG. 8 is a 2D EXIT chart showing trajectories according to detection-decoding ratios.

FIG. 9 is a graph showing an expected convergence rate according to detection-decoding ratios according to an embodiment of the disclosure.

FIG. 10 is a graph showing an actual convergence rate according to a detection-decoding ratios according to an embodiment of the disclosure.

FIG. 11 is a block diagram schematically showing an exemplary computing device that may be used to implement a method or apparatus according to the disclosure.

### DETAILED DESCRIPTION

Hereinafter, some embodiments of the disclosure will be described in detail using exemplary drawings. It should be noted that, when reference numerals are assigned to components in each drawings, the same components are given the same reference numerals as much as possible even if they are shown in different drawings. In addition, in describing the disclosure, when it is determined that a detailed description of related known configurations or functions may obscure the gist of the disclosure, the detailed description thereof will be omitted.

In describing the components of embodiments according to the disclosure, symbols such as first, second, i), ii), a), b), etc. may be used. These symbols are merely for distinguishing the component from other components, and do not limit the nature, order, or sequence of the corresponding components. In the specification, when a portion is described as “including” or “having” a certain component, this means that, unless explicitly stated to the contrary, other components are not excluded and may be further included.

The detailed description to be disclosed below together with the accompanying drawings is intended to describe exemplary embodiments of the disclosure and is not intended to represent the only embodiments in which the disclosure may be practiced.

When maximum likelihood (ML) techniques are applied to extreme massive MIMO systems, signal detection is theoretically possible. However, performing ML-based signal detection within the limited time required in practical environments involving the transmission and reception of large amounts of data is practically impossible due to computational complexity.

To overcome these problems, low-complexity signal detectors suitable for extreme massive MIMO systems have been developed, with representative techniques including FG-GAI-BP (full gaussian approximation-based iterative belief propagation), MMSE-SIC (minimum mean square error-successive interference cancellation), MMSE-PIC (minimum mean square error-parallel interference cancellation), Approximate MMSE-PIC, Gauss-seidel-aided MMSE-PIC, and the like.

These technologies extend signal detection performance that had remained at a theoretical level to practical environments, enabling transmission and reception of large amounts of data.

Meanwhile, in the field of MIMO systems, coded MIMO systems concatenating channel coding have been developed to increase communication reliability. By applying channel coding, stable data transmission is possible with significantly lower transmit power than conventional systems, and, due to this characteristic, such systems are widely utilized in various fields requiring low-power environments, such as satellite communications and undersea communications. Research on coded extreme massive MIMO systems incorporating channel coding is being actively conducted to secure high communication reliability under low transmission power conditions in extreme massive MIMO systems as well.

Types of channel coding include Turbo code, LDPC code, Polar code, and the like, among which, LDPC code is widely adopted in various standards and application fields. LDPC coded extreme massive MIMO systems incorporating LDPC code may simultaneously ensure high communication reliability and transmission and reception of large amounts of data. However, LDPC code have a disadvantage of high computational complexity, and therefore design techniques that simultaneously satisfy low amount of computation and excellent performance are required for efficient operation in practical environments.

To efficiently design such LDPC coded extreme massive MIMO systems, analysis of the entire data flow of the system is necessary. For this purpose, the extrinsic information transfer (EXIT) analysis method is widely utilized. The EXIT analysis method enables prediction of the performance of the entire system by analyzing only the input/output characteristics of each node constituting the system, without individually tracking all data flows when analyzing a system based on iterative operations. This is possible because it assumes that the input and output values of each node follow a Gaussian distribution.

Therefore, although the EXIT analysis method does not track all data individually, it provides comparable analytical effectiveness, serving as a useful tool that enables convenient and effective prediction and design of the performance of a complex system based on iterative operations.

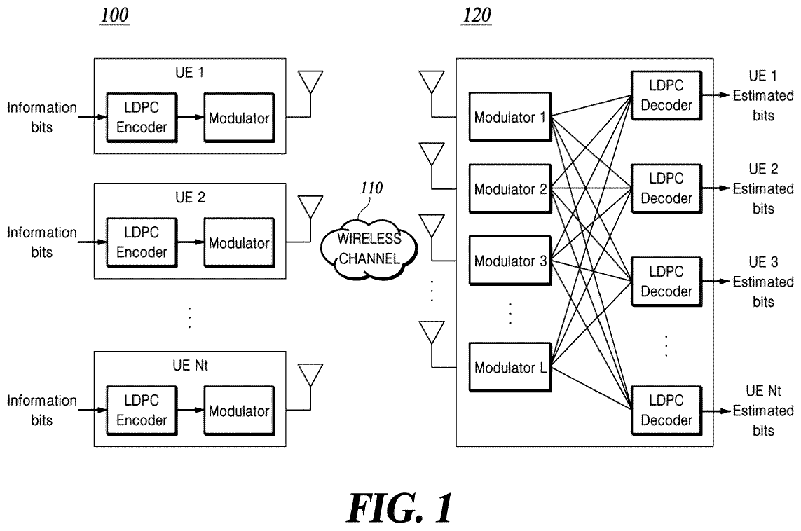

FIG. 1 is an exemplary diagram showing an LDPC coded extreme massive MIMO system.

A transmitter 100 receives information bits from respective user equipment (UE), converts the information bits into symbols through a modulator, and then transmits the symbols to a receiver 120 through a wireless channel 110 via a single transmit antenna.

The receiver 120 has multiple antennas, has signal detectors (hereinafter, “signal detector” is referred to as “detector”) equal in number L to the time slots in which the transmitted symbols are transmitted, and has LDPC decoders equal in number to the UEs.

It may be confirmed through Paper 1 that joint detection decoding, which operates by concatenating the detector and decoder, has excellent communication reliability compared to separate detection decoding, which operates the detector and decoder separately. However, joint detection decoding with excellent communication reliability has the disadvantage of requiring a high amount of computation, and design methods have been developed that may achieve excellent communication reliability with a low amount of computation.

There are various signal detectors used in coded extreme massive MIMO systems. Examples include ZF (Zero Forcing), MMSE (Minimum Mean Square Error), MMSE-SIC, MMSE-PIC, FG-GAI BP, and the like and decoders used in 5G/6G communications include LDPC code and polar code. Various design methods exist depending on the detector and decoder. Various design methods, such as system design methods using FG-GAI BP and LDPC code, and system design methods using MMSE-PIC and polar code, and the like have been disclosed through Papers 2 to 5.

The information on Papers 1 to 5 described in the specification is as follows:

Paper 1: Y. Shen, J. Yang, X. Zhou, X. You and C. Zhang, “Joint Detection and Decoding for Polar Co ded MIMO Systems,” GLOBECOM 2017-2017 IEEE Global Communications Conference, Singapore, pp. 1-6, 2017.

Paper 2: C. Cao, T. Koike-Akino, Y. Wang and S. C. Draper, “Irregular Polar Coding for Massive MIMO Channels,” GL OBECOM 2017-2017 IEEE Global Communications Conference, Singapore, pp. 1-7, 2017.

Paper3: Hwang, I.; Park, H. J.; Lee, J. W. LDPC Coded Massive MIMO Systems. Ent ropy, 21, 231, 2019.

Paper 4: H. J. Park and J. W. Lee, “LDPC Coded Multi-User Massive MIMO Systems With Low-Complexity Detection,” in IEEE Access, vol. 10, pp. 25296-25308, 2022

Paper 5: H. J. Park and J. W. Lee, “Design of LDPC Coded Multi-User Massive MIMO Systems With MMSE-Based Iterative Joint Detection and Decoding,” in IEEE Access, vol. 11, pp. 125492-125510, 2023.

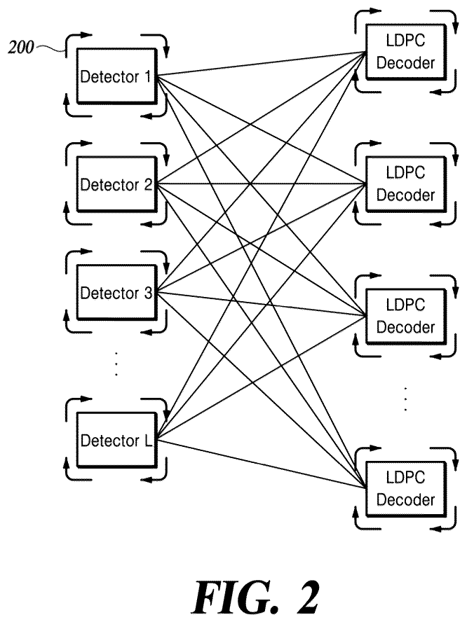

FIG. 2 is an exemplary diagram showing iterative operations of a detector and iterative operations of a decoder.

A plurality of detectors calculate symbol estimates from a received signal.

A plurality of LDPC decoders receive detection results from the detector and perform error correction.

An arrow 200 indicates that the plurality of detectors and the plurality of LDPC decoders iteratively exchange extrinsic information between each detector and decoder to update the detection results and decoding results.

The receiver 120 has a received signal [y₁^{(l)}, . . . , y_{N}_{ᵣ}^{(l)}]^{T} composed of symbols

$${X}^{( l )} = [ {x}_{1}^{( l )} , {x}_{2}^{( l )} , {x}_{3}^{( l )} , … , {x}_{{n}_{T}}^{( l )} ] ∈ {C}^{{n}_{T} \times 1}$$

transmitted from the transmitter 100, a channel gain matrix H^{(l)}, and a noise vector Z^{(l)}=[z₁^{(l)}, . . . , z_{N}_{^{r}}^{(l)}]^{T}. Y^{(l)} may be expressed as in Equation 1.

$${Y}^{( l )} = {H}^{( l )} {X}^{( l )} + {Z}^{( l )} , l = 1 , … , L \qquad [ Equation 1 ]$$

To concatenate the detector Gauss-seidel-aided MMSE-PIC with the LDPC decoder, the output of the Gauss-seidel-aided MMSE-PIC is defined as bit LLR Le. To compute Le, the received signal Y^{(l)} and nulling matrix W^{(l)H} are used. In addition, to improve communication reliability, the detector updates the nulling matrix W^{(l)H} for the next iterative operation through the average value La′ of Le and bit LLR La received from the LDPC decoder.

Through such structure of iterative operations of the detector and iterative operations of the decoder, the bit error rate (BER) may be significantly reduced compared to a simple detection-decoding structure, and stable transmission and reception of data is possible in extreme massive MIMO environments even with limited amount of computation.

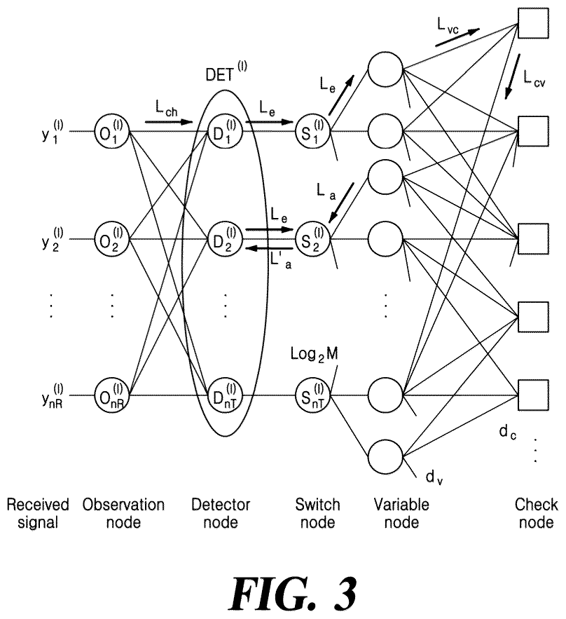

FIG. 3 is a structural diagram of an LDPC coded extreme massive MIMO system applied to an embodiment of the disclosure.

The received signal y is input to observation node, and observation values are output to detector node.

The detector node calculates symbol estimates based on the observation values and channel information, computes extrinsic information (Le) (based on log-likelihood ratio, LLR), and deliver it to the switch node. At this time, Le excludes information corresponding to itself and retains only information to be delivered externally.

The switch node combines the extrinsic information Le delivered from the detector node with the prior information La fed-back from the LDPC decoder and delivers the combined information to the variable node.

The variable node delivers an extrinsic message Lvc to the check node, based on the extrinsic information Le and the prior information La.

The check node delivers an extrinsic message Lcv back to the variable node, based on the LDPC constraint condition.

This process is performed by an LDPC iterative decoding algorithm (e.g., BP (belief propagation), SPA (sum-product algorithm), or the like).

The La′ generated from the LDPC decoder is delivered back to the detector node through the switch node.

The detector performs detection again reflecting the new prior information La′ and updates with improved extrinsic information Le.

As this process is iterated, the bit error rate (BER) gradually decreases and highly reliable data recovery is achieved.

An embodiment of the disclosure relates to a design method for an LDPC-coded extreme massive MIMO system with Gauss-seidel-aided MMSE-PIC. Since the LDPC coded extreme massive MIMO system with Gauss-seidel-aided MMSE-PIC requires a high amount of computation for operation, it is not suitable for practical use. Accordingly, there is a need for a design method that reduces the amount of computation and improves BER performance compared to existing methods for practical use. The MMSE-PIC detector, which is an MMSE-based signal detector, computes a Nulling Matrix W^{(l)H}=(H^{(l)H}H^{(l)}Δ^{(l)}+σ²I)⁻¹H^{(l)H}. Here, H^{(l)} represents the transmission and reception channel matrix, Δ^{(l)} represents a correction matrix reflecting weighting or signal power distribution, and σ²I represents a sum of noise multiplied by an identity matrix. (H^{H}HΔ+σ²I)⁻¹H^{H} represents a generalized form of the MMSE detection matrix, and when this matrix is multiplied by the received signal, interference may be suppressed and only the desired signal component may be extracted.

An inverse matrix operation requires a large amount of computation, and various techniques exist that apply methods capable of replacing the inverse matrix operation to reduce the amount of computation. Among them, there is the Gauss-seidel-aided MMSE-PIC technique that applies a Gauss-seidel method. Such techniques have served to reduce the amount of computation through inverse matrix approximation. However, to date, no optimal design technique has existed for the LDPC coded extreme massive MIMO system with Gauss-seidel-aided MMSE-PIC in consideration of both Gauss-seidel-aided MMSE-PIC and LDPC decoder. The disclosure proposes an optimal design method for the LDPC coded extreme massive MIMO system with Gauss-seidel-aided MMSE-PIC.

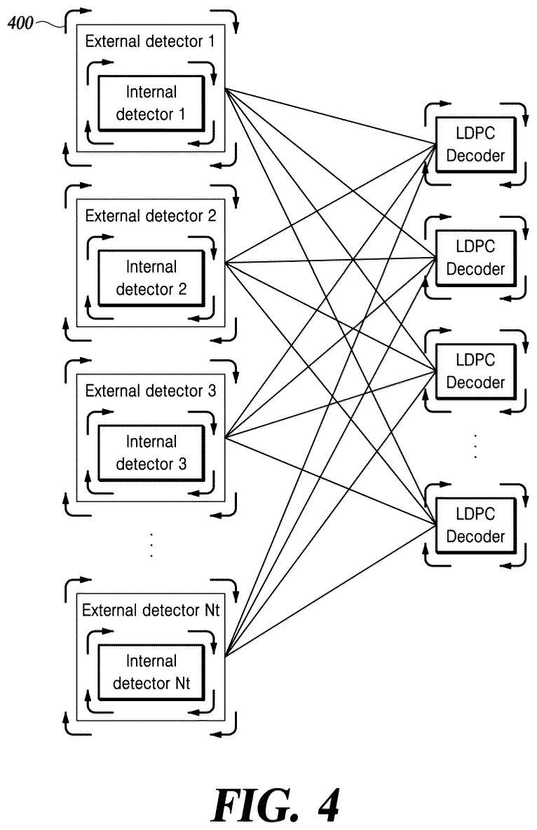

FIG. 4 is a structural diagram of a large-scale antenna wireless communication system based on an LDPC code and Gauss-seidel-aided MMSE-PIC according to an embodiment of the disclosure.

An arrow 400 means that the plurality of detectors (external detectors and internal detectors) and the plurality of LDPC decoders iteratively exchange extrinsic information between each detector (external detector and internal detector) and decoder to update detection results and decoding results.

The LDPC code and Gauss-seidel-aided MMSE-PIC-based large-scale antenna wireless communication system according to an embodiment of the disclosure is referred to as a decoding apparatus.

The decoding device includes detectors including external detectors and internal detectors, and LDPC decoders.

One cycle is defined as one iteration in which an internal algorithm of the internal detector or external detector updates itself once.

The external detector includes functions of a conventional detector.

In the case of PIC, the number of iterative operations of the external detector is determined by repeating, until convergence, a cycle as going through an initial estimation process, an interference cancellation process, and an update process.

In the case of successive interference cancellation (SIC), the number of iterative operations of the external detector is defined in different ways: in one definition, when users/streams are sequentially detected and cancelled one by one, processing each user (or stream) once is defined as one iteration, and in another definition, when the entire set of users is completely processed once, it is defined as one iteration cycle.

The internal detector performs, for example, Gauss-Seidel iterative operations.

The number of iterative operations of the internal detector is calculated based on the number of iterations performed until a residual norm or a difference between estimates in successive iterations converges less than or equal to a predetermined threshold value, in the process of approximating the inverse matrix using the Gauss-Seidel iterative method instead of directly performing the inverse matrix operation of the channel matrix to solve the linear equation for the received signal. The difference between estimates in successive iterations refers to the difference between a solution (estimate) obtained at a current step k and a solution (estimate) obtained at an immediately preceding step k-1 in the iterative algorithm.

The residual norm is an indicator representing how much a current approximate solution differs from an actual solution.

The number of iterative operations of the LDPC decoder is calculated based on the number of iterations performed, in a process of iteratively exchanging messages between variable node and check node, until any one of the following conditions is satisfied: all parity checks are satisfied; the estimates between successive iterations no longer change; or the difference in message values converges to less than or equal to a predetermined threshold value. The number of iterative operations of the LDPC decoder is calculated based on the number of iterations performed until the message exchange between variable node and check node satisfies convergence condition.

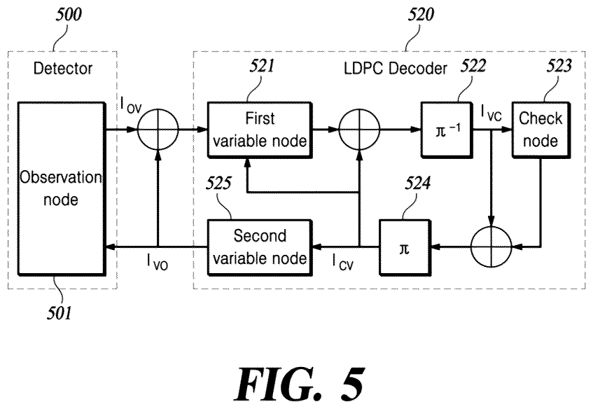

FIG. 5 is a system message flowchart showing a process of exchanging mutual information between a detector and an LDPC decoder according to an embodiment of the disclosure.

The decoding apparatus is composed of a detector 500 and an LDPC decoder 520.

Le and La in FIG. 3 are defined as Iov and Ivo in FIG. 5, and Lvc and Lcv in FIG. 3 are defined as Ivc and Icv in FIG. 5.

Referring to FIG. 5, a received signal is input to an observation node 501. The observation node 501 extracts an observation value from the received signal, calculates a symbol estimate based on the observation value, calculates Iov representing extrinsic information therefrom, and delivers the Iov to a first variable node 521. The first variable node 521 performs signal processing by combining the Iov and information Ivo fed-back from the LDPC decoder.

Information Ivc processed at the first variable node 521 is delivered to the check node 523 through a first interleaver Π-1 522. The check node 523 delivers the extrinsic message Icv back to a second variable node 525 through a second deinterleaver Π 524, based on the LDPC constraint condition.

This message exchange between the variable node and check node is performed iteratively, proceeding according to LDPC iterative decoding procedures such as the BP algorithm or SPA.

The extrinsic information Ivo calculated at the second variable node 525 is delivered back to the observation node 501 to be reflected in the detector operation. The observation node 501 recalculates improved extrinsic information Iov using new prior information, and this process gradually obtains more reliable symbol restoration results through iteration.

Therefore, the system according to an embodiment of the disclosure may reduce the bit error rate (BER) and improve the restoration performance of transmitted data by iteratively performing mutual information exchange between the detector and the LDPC decoder.

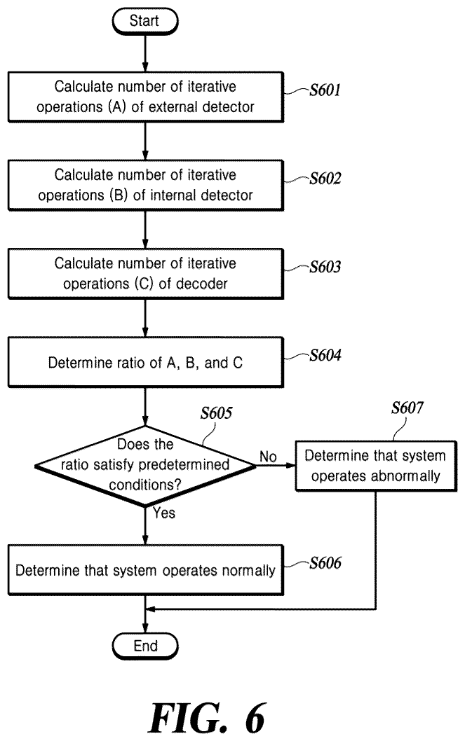

FIG. 6 is a flowchart showing a decoding method according to an embodiment of the disclosure.

In step 601, the decoding apparatus calculates the number of iterative operations A, Ndet of the external detector.

In the case of PIC, the number of iterative operations of the external detector is determined by repeating, until convergence, a cycle as going through an initial estimation process, an interference cancellation process, and an update process.

In the case of successive interference cancellation (SIC), the number of iterative operations of the external detector is defined in different ways: in one definition, when users/streams are sequentially detected and cancelled one by one, processing each user (or stream) once is defined as one iteration, and in another definition, when the entire set of users is completely processed once, it is defined as one iteration cycle.

In step 602, the decoding apparatus calculates the number of iterative operations B, Ngs of the internal detector.

The number of internal iterative operations of the internal detector is calculated using the number of a Gauss-Seidel iterative operations.

That is, the number of iterative operations of the internal detector is calculated based on the number of iterations performed until the residual norm or a difference between estimates in successive iterations converges less than or equal to the predetermined threshold value, in the process of approximating the inverse matrix using the Gauss-Seidel iterative method instead of directly performing the inverse matrix operation of the channel matrix to solve the linear equation for the received signal.

In step 603, the decoding apparatus calculates the number of iterative operations C, Ndec of the LDPC decoder.

The number of iterative operations of the LDPC decoder is calculated based on the number of iterations performed, in a process of iteratively exchanging messages between variable node and check node, until any one of the following conditions is satisfied: all parity checks are satisfied; the estimates between successive iterations no longer change; or the difference in message values converges to less than or equal to the predetermined threshold value. The number of iterative operations of the LDPC decoder is calculated based on the number of iterations performed until the message exchange between variable node and check node satisfies convergence condition.

Steps 601, 602, and 603 are not limited in their order of execution and may proceed in any order.

In step 604, the decoding apparatus determines a ratio of A, B, and C.

In step 605, the decoding apparatus determines whether the ratio satisfies a predetermined condition.

For example, the predetermined condition includes a case in which Ivc=1 is first reached or a case in which the bit error rate approaches zero.

In step 606, the decoding apparatus determines that the system operates normally when the predetermined condition is satisfied.

In step 607, the decoding apparatus determines that the system operates abnormally when the predetermined condition is not satisfied.

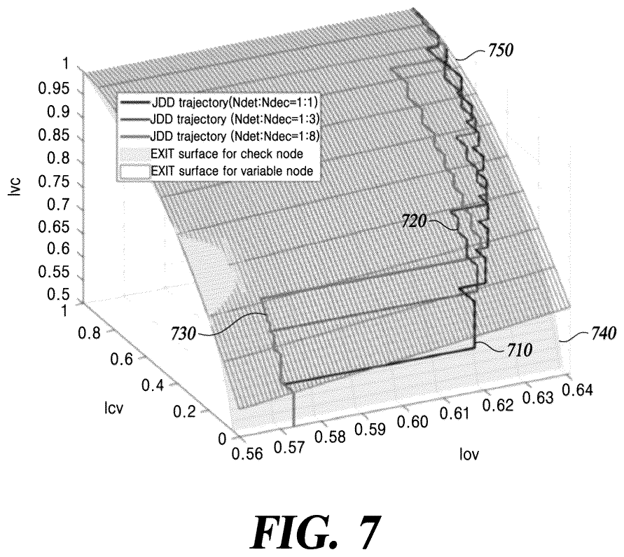

FIG. 7 is a 3D EXIT chart showing trajectories according to detection-decoding ratios. Reference numeral 710 denotes a case in which Ndet:Ndec is 1:1.

Reference numeral 720 denotes a case in which Ndet:Ndec is 1:3.

Reference numeral 730 denotes a case in which Ndet:Ndec is 1:8.

Reference numeral 740 denotes an EXIT surface for check node.

Reference numeral 740 denotes an EXIT surface for variable node.

Through EXIT analysis, a 3D chart as shown in FIG. 7 may be obtained. As shown in FIG. 7, various trajectories according to the ratios may be visually confirmed. Here, Ndet denotes the number of iterative operations of the detector, and Ndec denotes the number of iterative operations of the LDPC decoder.

Referring to FIG. 7, the cases where Ndet:Ndec is 1:1, Ndet:Ndec is 1:3, and Ndet:Ndec is 1:8 are shown.

It may be confirmed that each reaches Ivc=1 through different trajectories according to the respective Ndet:Ndec ratios. Reaching Ivc=1 means that the decoding device (LDPC coded extreme massive MIMO system with Gauss-seidel-aided MMSE-PIC) designed based on the results obtained through the EXIT analysis operates normally.

According to an embodiment of the disclosure, when Ngs is further applied, the staircase-shaped pattern shown in FIG. 7 is changed.

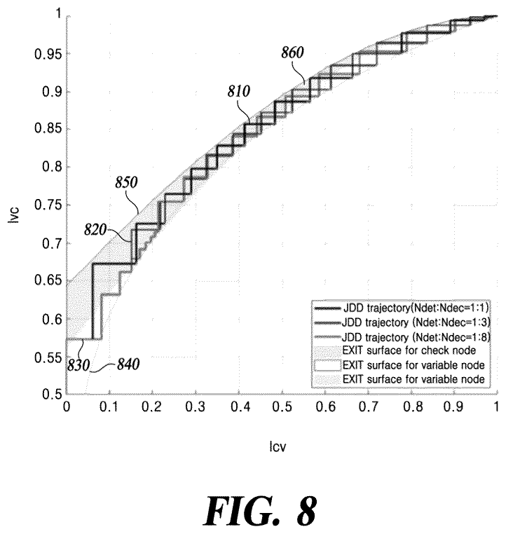

FIG. 8 is a 2D EXIT chart showing trajectories according to detection-decoding ratios.

Reference numeral 810 denotes a case in which Ndet:Ndec is 1:1.

Reference numeral 820 denotes a case in which Ndet:Ndec is 1:3.

Reference numeral 830 denotes a case in which Ndet:Ndec is 1:8.

Reference numeral 840 denotes an EXIT surface for check node.

Reference numeral 850 denotes an EXIT surface for variable node and a boundary, the variable node EXIT curve itself (line graph).

Reference numeral 860 denotes an EXIT surface for variable node and a region formed between the variable node EXIT curve and the check node EXIT curve.

FIG. 8 illustrates, in two dimensions, the staircase-shaped pattern shown in FIG. 7.

According to an embodiment of the disclosure, when Ngs is further applied, the staircase-shaped pattern shown in FIG. 8 is changed.

Through EXIT analysis, a 2D chart as shown in FIG. 7 may be obtained. As shown in FIG. 8, various trajectories according to the ratios may be visually confirmed. Here, Ndet denotes the number of iterative operations of the detector, and Ndec denotes the number of iterative operations of the LDPC decoder.

Referring to FIG. 7, the cases where Ndet:Ndec is 1:1, Ndet:Ndec is 1:3, and Ndet:Ndec is 1:8 are shown.

Reaching Ivc=1 means that the designed system decodes normally, which this may be visually confirmed through the 2D chart.

Referring to FIG. 7 and FIG. 8, it may be confirmed that the length to reach Ivc=1 differs depending on the ratio of Ndet:Ndec. When designing with this aspect in consideration, finding an optimal ratio of Ndet:Ndec makes it possible to reach Ivc=1 most quickly, which means that decoding is completed with the least amount of computation.

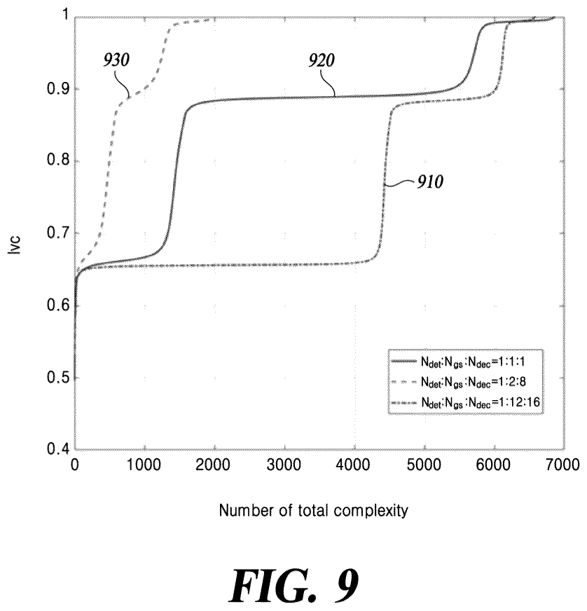

FIG. 9 is a graph showing an expected convergence rate according to detection-decoding ratios according to an embodiment of the disclosure.

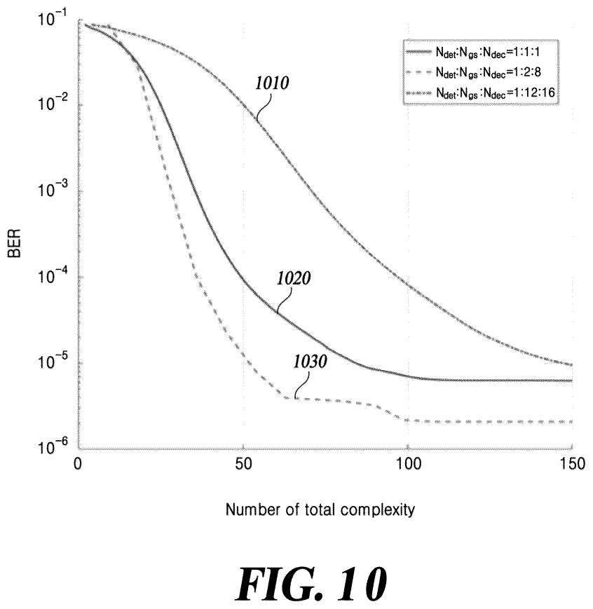

FIG. 9 and FIG. 10 show the results of defining the number of steps shown in FIG. 7 and FIG. 8 as computational complexity. In particular, FIG. 9 shows the relationship between the magnitude of computational complexity and Ivo.

Ndet denotes the number of iterative operations of the external detector, Ngs denotes the number of iterative operations of the internal detector, and Ndec denotes the number of iterative operations of the LDPC decoder. It may be confirmed that depending on each ratio of Ndet:Ngs:Ndec, each reaches Ivc=1 through different trajectories. Ivc=1 indicates that the amount of extrinsic information delivered from the variable node has reached its maximum, and this may be confirmed through the EXIT chart.

Reference numeral 910 denotes a case in which Ndet:Ngs:Ndec is 1:12:16.

Reference numeral 920 denotes a case in which Ndet:Ngs:Ndec is 1:1:1.

Reference numeral 930 denotes a case in which Ndet:Ngs:Ndec is 1:2:8.

It may be confirmed that reference numeral 930 reaches Ivc=1 first, indicating that Ndet:Ngs:Ndec=1:2:8 (this ratio combination) completes decoding with the least amount of computation.

Reaching Ivc=1 first means that the decoding device (LDPC coded extreme massive MIMO system with Gauss-seidel-aided MMSE-PIC) designed based on the results obtained through the EXIT analysis operates normally.

FIG. 10 is a graph showing an actual convergence rate according to a detection-decoding ratios according to an embodiment of the disclosure.

Ndet denotes the number of iterative operations of the external detector, Ngs denotes the number of iterative operations of the internal detector, and Ndec denotes the number of iterative operations of the LDPC decoder. It may be confirmed that depending on each ratio of Ndet:Ngs:Ndec, each reaches BER through different trajectories.

Reference numeral 1010 denotes a case in which Ndet:Ngs:Ndec is 1:12:16.

Reference numeral 1020 denotes a case in which Ndet:Ngs:Ndec is 1:1:1.

Reference numeral 1030 denotes a case in which Ndet:Ngs:Ndec is 1:2:8.

It may be confirmed that reference numeral 1030 first reaches the best BER performance. This means that Ndet:Ngs:Ndec=1:2:8 (this ratio combination) completes decoding with the least amount of computation. It is determined that Ndet:Ngs:Ndec=1:2:8 (this ratio combination) is the optimal combination.

Reaching the best BER performance first means that the decoding apparatus (LDPC coded extreme massive MIMO system with Gauss-seidel-aided MMSE-PIC) designed based on results obtained through EXIT analysis operates normally.

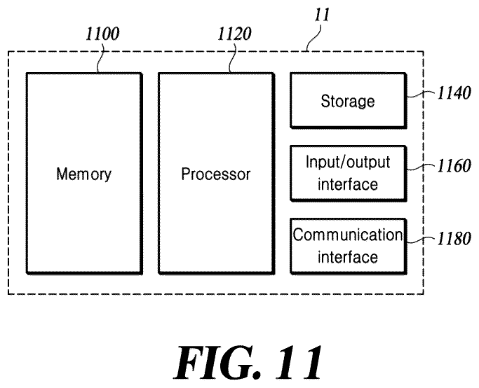

FIG. 11 is a block diagram schematically showing an exemplary computing device that may be used to implement a method or apparatus according to the disclosure.

The computing device 11 may structurally and/or functionally include at least a portion of the LDPC decoding apparatus. The computing device 11 may include some or all of a memory 1100, a processor 1120, a storage 1140, an input/output interface 1160, and a communication interface 1180.

The computing device 11 may be not only a stationary computing device such as a desktop computer, a server, and the like, but also a mobile computing device such as a laptop computer, a smartphone, and the like. The computing device 11 may also be implemented as a specialized hardware accelerator for efficiently processing LDPC decoding operations. For example, the computing device 11 may include a graphics processing unit (GPU), a tensor processing unit (TPU), or a neural processing unit (NPU).

The memory 1100 may store a program that causes the processor 1120 to perform an LDPC decoding method or operations. For example, the program may include a plurality of instructions executable by the processor 1120, and the aforementioned LDPC decoding or operations may be performed by the plurality of instructions being executed by the processor 1120. The memory 1100 may be a single memory or a plurality of memories. In this case, information required to perform LDPC decoding or operations according to various embodiments of the disclosure may be stored in a single memory or divided and stored in a plurality of memories. When the memory 1100 is composed of a plurality of memories, the plurality of memories may be physically separated. The memory 1100 may include at least one of volatile memory and non-volatile memory. The volatile memory includes static random access memory (SRAM), dynamic random access memory (DRAM) or the like, and the non-volatile memory includes flash memory or the like.

The processor 1120 may include at least one core capable of executing at least one instruction. The processor 1120 may execute instructions stored in the memory 1100. The processor 1120 may be a single processor or a plurality of processors.

The storage 1140 may store LDPC decoding-related programs and data (e.g., parity-check matrix H, decoding algorithm parameters, trained decoding models, and the like) and may maintain data even when power is cut off. Programs stored in the storage 1140 may be loaded into the memory 1100 before being executed by the processor 1120. The storage 1140 may store files written in a programming language, and programs generated from the files by a compiler or the like may be loaded into the memory 1100. The storage 1140 may store data to be processed by the processor 1120 and/or data processed by the processor 1120. For example, the storage 1140 may store models optimized for a specific program (and/or a specific version thereof).

The input/output interface 1160 may include input devices such as a keyboard and a mouse, and may include output devices such as a display device and a printer. A user may trigger execution of a program by the processor 1120 and/or confirm processing results of the processor 1120 through the input/output interface 1160.

The input/output interface 1160 may include a device capable of receiving LDPC decoding commands from a user or an external device, or outputting LDPC decoding results (e.g., restored bit sequences, decoding performance indicators, and the like).

The communication interface 1180 may provide access to an external network. The computing device 11 may communicate with other device through the communication interface 1180. The communication interface 1180 enables communication with the external network or other device, and the computing device 11 may exchange data with a transmitter or an upper network device through the communication interface 1180. For example, a received signal y or channel information may be input through the communication interface 1180, and decoded data may be transmitted back to the external device.

At least some of the components described in the exemplary embodiments of the disclosure may be implemented as hardware elements including at least one of a DSP (Digital Signal Processor), a processor, a controller, an ASIC (Application-Specific IC), a programmable logic device (such as an FPGA), and other electronic components, or a combination thereof. In addition, at least some of the functions or processes described in the exemplary embodiments may be implemented in software, and the software may be stored on a recording medium. At least some of the components, functions, and processes described in the exemplary embodiments of the disclosure may be implemented as a combination of hardware and software.

The method according to the exemplary embodiments of the disclosure may be written as a program executable on a computer, and may also be implemented on various recording media such as magnetic storage media, optical readable media, and digital storage media.

The implementations of the various technologies described in the present specification may be implemented in digital electronic circuitry, or in computer hardware, firmware, software, or combinations thereof. The implementations may be implemented as a computer program product, i.e., a computer program tangibly embodied in an information carrier, e.g., in a machine-readable storage device (computer-readable medium) or in a propagated signal, for processing by, or to control the operation of, data processing apparatus, e.g., a programmable processor, a computer, or multiple computers. Computer programs such as the computer program(s) described above may be written in any form of programming language, including compiled or interpreted languages, and may be deployed in any form, including as a stand-alone program or as modules, components, subroutines, or other units suitable for use in a computing environment. The computer program may be deployed to be processed on one computer or on multiple computers at one site, or distributed across multiple sites and interconnected by a communication network.

Processors suitable for the processing of the computer program include, by way of example, both general-purpose and special-purpose microprocessors, and any one or more processors of any kind of digital computer. Generally, a processor will receive instructions and data from a read-only memory, a random access memory or both. The elements of a computer may include at least one processor for executing instructions and one or more memory devices for storing instructions and data. Generally, the computer may also include, or be operatively coupled to receive data from or transmit data to, or both one or more mass storage devices for storing data, such as magnetic disks, magneto-optical disks, or optical disks. Information carriers suitable for embodying computer program instructions and data include, by way of example, semiconductor memory devices, for example magnetic media such as hard disk, floppy disk, and magnetic tape; optical media such as CD-ROM (compact disc read only memory) and DVD (digital video disc); magneto-optical media such as floptical disk; and ROM (read only memory), RAM (random access memory), flash memory, EPROM (erasable programmable ROM), EEPROM (electrically erasable programmable ROM); and the like. The processor and the memory may be supplemented by, or incorporated in, special-purpose logic circuitry.

The processor may execute an operating system and software applications running on the operating system. In addition, the processor device may access, store, manipulate, process, and generate data in response to execution of software. For convenience of understanding, although a processor device may be described as being singular, those skilled in the art will understand that the processor device may include multiple processing elements and/or multiple types of processing elements. For example, the processor device may include multiple processors or one processor and one controller. Other processing configurations, such as parallel processors, are also possible.

In addition, non-transitory computer-readable media may be any available media that may be accessed by a computer and may include both computer storage media and transmission media.

The present specification contains details of numerous specific implementations, but these should not be understood as limiting the scope of any invention or of what may be claimed, and rather should be understood as descriptions of features that may be specific to certain embodiments of certain inventions. Certain features described in the present specification in the context of individual embodiments may also be implemented in combination in a single embodiment. Conversely, various features described in the context of a single embodiment may also be implemented individually or in any suitable sub-combination in multiple embodiments. Furthermore, although features may be described as operating in certain combinations and initially claimed as such, one or more features from the claimed combination may, in some cases, be excluded from the combination, and the claimed combination may be modified into a sub-combination or a variation of a sub-combination.

Similarly, although operations are depicted in the drawings in a particular order, this should not be understood as requiring that such operations be performed in that particular order or in sequential order illustrated, or that all illustrated operations be performed, to obtain a desired result. In certain cases, multitasking and parallel processing may be advantageous. In addition, the separation of various device components in the embodiments described above should not be understood as requiring such separation in all embodiments, and it should be understood that the described program components and devices may generally be integrated together into a single software product or packaged into multiple software products.

Meanwhile, the embodiments of the disclosure disclosed in the present specification and drawings are merely presented as specific examples to aid understanding, and are not intended to limit the scope of the disclosure. It will be apparent to those skilled in the art that other modifications based on the technical spirit of the disclosure may be implemented in addition to the embodiments disclosed herein.

The scope of protection of the embodiment should be interpreted by the claims below, and all technical ideas within the equivalent scope thereof should be construed as being included in the scope of rights of the embodiment.

What is claimed is:

1. A decoding method in a large-scale antenna wireless communication system, comprising:
calculating the number of iterative operations of an external detector;
calculating the number of iterative operations of an internal detector;
calculating the number of iterative operations of an LDPC (Low-Density Parity-Check) decoder;
determining a ratio of the number of iterative operations of the external detector, the number of iterative operations of the internal detector, and the number of iterative operations of the LDPC decoder; and
determining that the system operates normally when the determined ratio satisfies a predetermined condition.

2. The decoding method according to claim 1, wherein
the number of iterative operations of the internal detector is calculated using the number of a Gauss-Seidel iterative operations.

3. The decoding method according to claim 1, wherein
the predetermined condition comprises a case in which Ivc=1 is first reached.

4. The decoding method according to claim 1, wherein
the predetermined condition comprises a case in which a bit error rate approaches zero.

5. The decoding method according to claim 3, wherein the Ivc=1 indicates that an amount of extrinsic information delivered from variable node has reached a maximum.

6. The decoding method according to claim 5, wherein
the Ivc=1 is determined using an EXIT (extrinsic information transfer) analysis.

7. The decoding method according to claim 1, wherein
the determining that the system operates normally comprises:
determining that the system operates normally when the determined ratio first reaches Ivc=1 at a minimum complexity.

8. The decoding method of claim 1, wherein
the number of iterative operations of the LDPC decoder is calculated based on the number of iterations performed until message exchange between variable node and check node satisfy a convergence condition.

9. The decoding method according to claim 1, further comprising:
determining that the system operates abnormally when the determined ratio does not satisfy the predetermined condition.

10. The decoding method according to claim 1, wherein the number of iterative operations of the internal detector is calculated, in a process of approximating an inverse matrix by a Gauss-Seidel iterative method to solve a linear equation for the received signal, using one of a residual norm and a difference between estimates in successive iterations.

11. A decoding apparatus in a large-scale antenna wireless communication system, comprising:
a memory including instructions; and
a processor configured, by executing the instructions, calculates the number of iterative operations of an external detector, to calculate the number of iterative operations of an internal detector, calculate the number of iterative operations of an LDPC (Low-Density Parity-Check) decoder, check a ratio of the number of iterative operations of the external detector, the number of iterative operations of the internal detector, and the number of iterative operations of the LDPC decoder, and determine that the system operates normally when the checked ratio satisfies a predetermined condition.

12. The decoding apparatus according to claim 11, wherein
the number of iterative operations of the internal detector is calculated using the number of a Gauss-Seidel iterative operations.

13. The decoding apparatus according to claim 11, wherein
the predetermined condition comprises a case in which Ivc=1 is first reached.

14. The decoding apparatus according to claim 11, wherein
the predetermined condition comprises a case in which a bit error rate approaches zero.

15. The decoding apparatus according to claim 13, wherein
the Ivc=1 indicates that an amount of extrinsic information delivered from variable node has reached a maximum.

16. The decoding apparatus according to claim 15, wherein the Ivc=1 is determined using an EXIT (Extrinsic Information Transfer) analysis.

17. The decoding apparatus according to claim 11, wherein the processor:
determining that the system operates normally when the determined ratio first reaches Ivc=1 at a minimum complexity.

18. The decoding apparatus according to claim 11, the number of iterative operations of the LDPC decoder is calculated based on the number of iterations performed until message exchange between variable node and check node satisfy a convergence condition.

19. The decoding apparatus according to claim 11, wherein the processor is further configured to determine, based on a combination of the ratios, that the system operates abnormally when the determined ratio does not satisfy a predetermined condition.

20. The decoding apparatus according to claim 11, wherein the number of iterative operations of the internal detector is calculated, in a process of approximating an inverse matrix by a Gauss-Seidel iterative method to solve a linear equation for the received signal, using one of a residual norm and a difference between estimates in successive iterations.
